(19) United States
(12) Patent Application Publication
(10) Pub. No.: US 2024/0115937 A1
(43) Pub. Date: Apr. 11, 2024

(54) HAPTIC ASSET GENERATION FOR ECCENTRIC ROTATING MASS (ERM) FROM LOW FREQUENCY AUDIO CONTENT

(71) Applicant: Sony Interactive Entertainment Inc., Tokyo (JP)

(72) Inventors: Celeste Bean, San Mateo, CA (US); Christopher M. Pontiga, San Mateo, CA (US); Arthur Kwun, San Mateo, CA (US)

(21) Appl. No.: 18/045,796

(22) Filed: Oct. 11, 2022

(51) Int. Cl. A63F 13/285; A63F 13/24; A63F 13/424; A63F 13/533

(52) U.S. Cl. CPC A63F 13/285; A63F 13/24; A63F 13/424; A63F 13/533

(57) ABSTRACT

Computer game developers can implicitly create haptic assets from audio assets. A low pass filter passes only audio assets with frequencies less than a threshold to a mapping module. The audio assets are then mapped to haptic assets that can be output by an ERM of a computer game controller. The haptic output can be in synchronization with play of the audio assets on speakers.

### FIELD

The present application relates generally to haptic asset generation for haptic generators such as eccentric rotating masses (ERM) from audio content such as low frequency audio content.

### BACKGROUND

As understood herein, many computer simulations such as computer games are enhanced using haptic generation to, e.g., vibrate the computer game controller.

### SUMMARY

As further understood herein, it would be advantageous to allow game developers to implicitly create haptic assets.

Accordingly, an apparatus includes at least one processor configured to receive at least one audio asset from at least one computer simulation. The processor is configured to, responsive to the audio asset satisfying a frequency, generate a haptic asset, and use the haptic asset to activate at least one haptic generator in at least one computer simulation controller.

In some embodiments the frequency may be two hundred Hertz (200 Hz) or less.

In example implementations the processor may be configured to process the audio asset through at least one low pass filter prior to using the audio asset to generate the haptic asset.

An example haptic generator includes at least one eccentric rotating mass (ERM) device. The ERM can have a motor comprising a shaft extending into a hollow permanent magnet and coupled to an eccentric mass via the shaft.

If desired, the processor may be configured to present on at least one display at least one user interface (UI) comprising at least one input element selectable to enable or disable generating the haptic asset from the audio asset.

In another aspect, a method includes receiving at least one audio asset from at least one computer simulation, processing the audio asset through at least one low pass filter prior to using the audio asset to generate a haptic asset, and using the haptic asset to activate at least one haptic generator in at least one computer simulation controller.

In another aspect, a device includes at least one computer storage that is not a transitory signal and that in turn includes instructions executable by at least one processor to receive at least one audio asset from at least one computer simulation, responsive to metadata in the audio asset, generate a haptic asset, and use the haptic asset to activate at least one haptic generator in at least one computer simulation controller.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates first example logic in example flow chart format;

FIG. 4 illustrates second example logic in example flow chart format;

FIG. 5 illustrates example signal processing;

FIG. 6 illustrates a screen shot of an example user interface (UI);

FIG. 7 illustrates an exploded perspective view of an example ERM; and

FIG. 8 illustrates third example logic in example flow chart format;

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

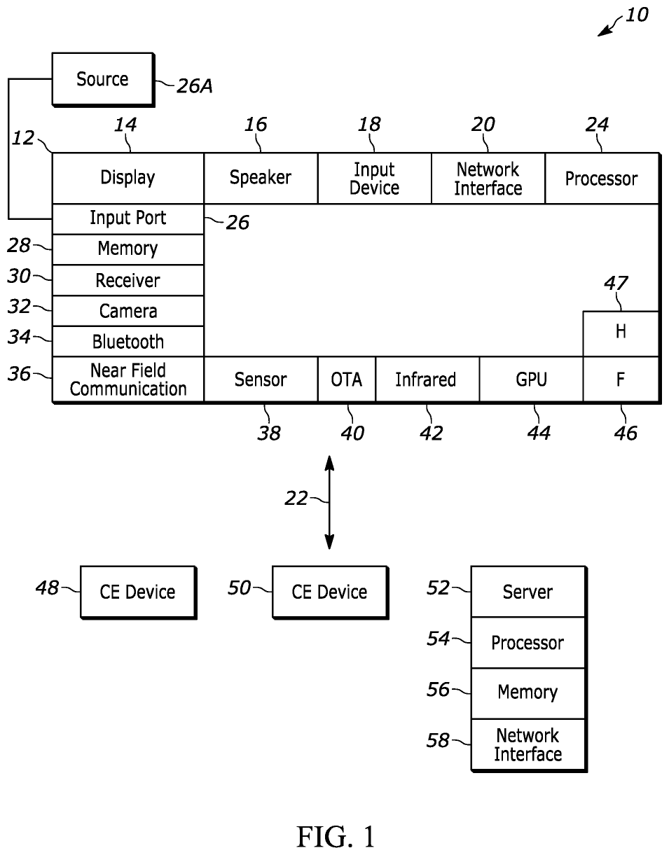

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

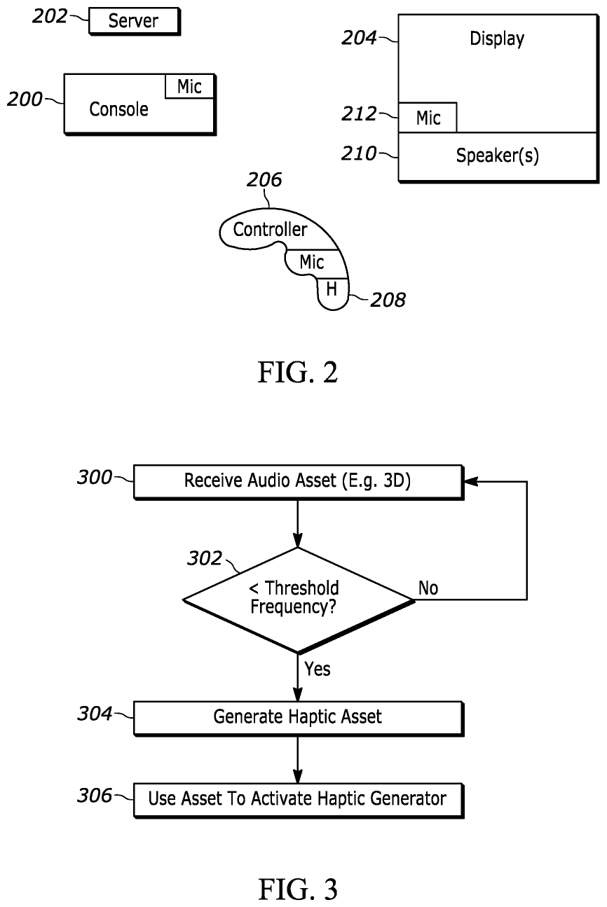

Refer now to FIG. 2. A computer simulation such as a computer game may be sent from a computer game console 200 or a computer game server 202 to a display device 204 such as a TV for presentation of the computer simulation under control of one or more computer simulation controllers 206, such as but not limited to a PlayStation® controller or other controller.

One or more haptic generators 208 may be provided on the controller 206, which can be operated by a player to control presentation of the computer simulation. Audio sourced from the game console 200 or server 202 is played on one or more speakers 210 of a speaker system. The elements of the system shown in FIG. 2 can incorporate some or all of the appropriate devices and components described above in reference to FIG. 1. One or more of the components in FIG. 2 may include one or more microphones 212.

Refer now to FIG. 3. Commencing at block 300, an audio asset is identified or received. The audio asset may be a 3D audio asset from a computer simulation such as a computer game. The audio asset may represent, for example, sound from a virtual object in the computer simulation, and may be played on the speaker shown in FIG. 2.

Moving to decision diamond 302, if the frequency of the audio asset is at or below a threshold frequency, e.g., two hundred Hertz (200 Hz), the logic moves to block 304 to generate a haptic asset, essentially a signal to activate a haptic generator. In an example, a haptic asset may encode a waveform used for vibrotactile display.

The haptic asset is used at block 306 to activate one or more haptic generators shown in FIG. 2. The haptic asset may have a duration equal to or about equal to the duration of the audio asset that was used to generate it. Or, the haptic asset may have a longer or shorter duration than the audio asset used to generate it. The amplitude of the haptic asset may be proportional to the amplitude of the audio asset used to generate the haptic asset. The frequency embodied in the haptic asset to activate the haptic generator at that frequency may be the same frequency as the audio asset.

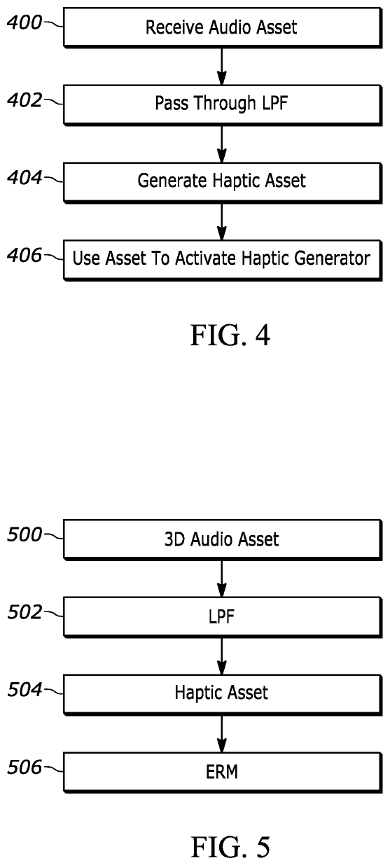

Refer now to FIG. 4. Commencing at block 400, an audio asset is identified or received. The audio asset may be a 3D audio asset from a computer simulation such as a computer game. The audio asset may represent, for example, sound from a virtual object in the computer simulation, and may be played on the speaker shown in FIG. 2. Moving to block 402, the frequency of the audio asset may be cut off at a threshold frequency by passing the audio through a low pass filter, it being understood that the audio asset may be played on a speaker prior to passing the audio asset through the low pass filter. The low pass filter may cut off frequencies at or above a threshold frequency, e.g., two hundred Hertz (200 Hz). The low pass filter may be implemented in the digital domain on a processor, DSP, or fixed-function operation in a codec, or in the analog domain simply with active and/or passive discrete components without the need for a processor. However, note that any type of filter (low-pass, bandpass, or high-pass filter) can be used to extract from the audio channel and generate haptic assets. Any band of frequencies can be extracted from the audio channel with a filter and used to generate haptic assets. For example, in the Dual Sense controller, the haptics may be driven with a wideband of audio signals using a haptic generator that includes a speaker coupled to a heavy-weighted diaphragm. The only limitation for the band of frequencies is that the haptic is capable of operation in that range.

Next, the logic moves to block 404 to generate a haptic asset, essentially a signal to activate a haptic generator. The haptic asset is used at block 406 to activate one or more haptic generators shown in FIG. 2. The haptic asset may have a duration equal to or about equal to the duration of the audio asset that was used to generate it. Or, the haptic asset may have a longer or shorter duration than the audio asset used to generate it. The amplitude of the haptic asset may be proportional to the amplitude of the audio asset used to generate the haptic asset. The frequency embodied in the haptic asset to activate the haptic generator at that frequency may be the same frequency as the audio asset. FIG. 5 illustrates further. a 3D audio asset 500 is passed through a low pass filter 502 to generate a haptic asset 504. The haptic asset is sent to a haptic generator 506 such as an eccentrical rotatable mass (ERM) generator, although other haptic generators such as piezeos or linear actuators or weighted voice coils may be used.

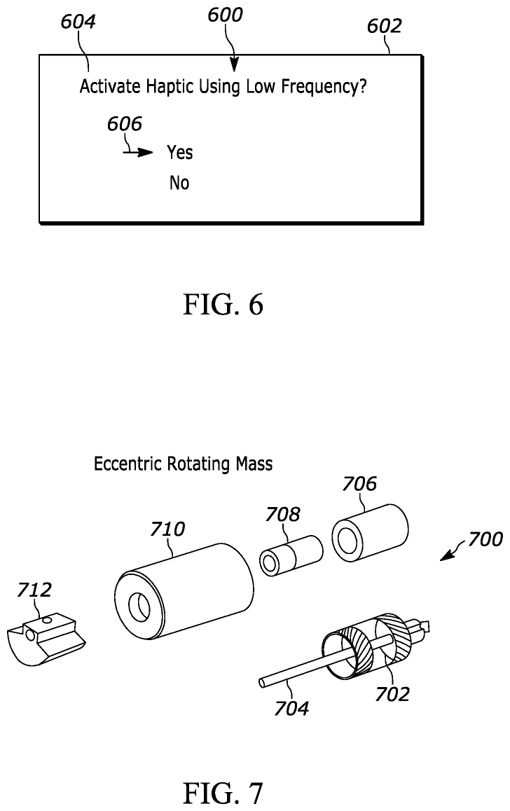

FIG. 6 illustrates a user interface (U) 600 that may be presented on a display 602 audibly or visually. The UI 600 can include a prompt 604 for the user to select whether to generate haptic assets from audio assets. Selectors 606 are provided to this end.

FIG. 7 illustrates an exploded view of an example ERM 700. In the non-limiting example shown, the ERM 700 includes a motor 702 with a shaft 704 that can extend through a hollow magnet 706 and bearing 708. The components 702-708 may be contained in a motor housing 710.

The shaft 704 of the motor 702 is coupled to an eccentric mass 712. The eccentric mass 712 shown in FIG. 7 has a transverse cross-section that is not symmetric about the axis of rotation. In the non-limiting example shown, the eccentric mass 712 has something less than a full semi-circular cross-section.

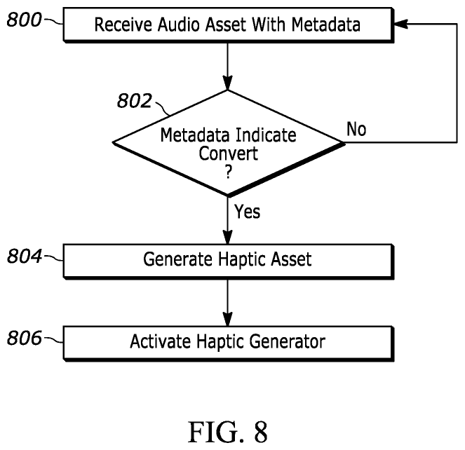

Refer now to FIG. 8. Commencing at block 800, an audio asset is identified or received. The audio asset may be a 3D audio asset from a computer simulation such as a computer game. The audio asset may represent, for example, sound from a virtual object in the computer simulation, and may be played on the speaker shown in FIG. 2.

Moving to decision diamond 802, it is determined whether metadata accompanying the audio asset indicates whether the audio asset is to be used to activate the haptic generator, e.g., by generating a corresponding haptic asset. If so, the logic moves to block 804 to generate a haptic asset, essentially a signal to activate a haptic generator. The haptic asset is used at block 806 to activate one or more haptic generators shown in FIG. 2.

The haptic asset may have a duration equal to or about equal to the duration of the audio asset that was used to generate it. Or, the haptic asset may have a longer or shorter duration than the audio asset used to generate it. The amplitude of the haptic asset may be proportional to the amplitude of the audio asset used to generate the haptic asset. The frequency embodied in the haptic asset to activate the haptic generator at that frequency may be the same frequency as the audio asset.

While the particular embodiments are herein shown and described in detail, it is to be understood that the subject matter which is encompassed by the present invention is limited only by the claims.

What is claimed is:

1. An apparatus comprising:
at least one processor configured to:
receive at least one audio asset from at least one computer simulation;
responsive to the audio asset satisfying a frequency, generate a haptic asset; and
use the haptic asset to activate at least one haptic generator in at least one computer simulation controller.

2. The apparatus of claim 1, wherein the frequency is two hundred Hertz (200 Hz) or less.

3. The apparatus of claim 1, wherein the processor is configured to:
process the audio asset through at least one low pass filter prior to using the audio asset to generate the haptic asset.

4. The apparatus of claim 1, wherein the haptic generator comprises at least one eccentric rotating mass (ERM) device.

5. The apparatus of claim 1, wherein the processor is configured to:
present on at least one display at least one user interface (UI) comprising at least one input element selectable to enable or disable generating the haptic asset from the audio asset.

6. The apparatus of claim 1, wherein the ERM device comprises:
a motor comprising a shaft extending into a hollow permanent magnet and coupled to an eccentric mass via the shaft.

7. A method, comprising:
receiving at least one audio asset from at least one computer simulation;
processing the audio asset through at least one low pass filter prior to using the audio asset to generate a haptic asset; and
using the haptic asset to activate at least one haptic generator in at least one computer simulation controller.

8. The method of claim 7, wherein the low pass filter has a threshold of two hundred Herz (200 Hz) or less.

9. The method of claim 7, wherein the haptic generator comprises at least one eccentric rotating mass (ERM) device.

10. The method of claim 7, comprising:
presenting on at least one display at least one user interface (UI) comprising at least one input element selectable to enable or disable generating the haptic asset from the audio asset.

11. The method of claim 9, wherein the ERM device comprises:
a motor comprising a shaft extending into a hollow permanent magnet and coupled to an eccentric mass via the shaft.

12. A device comprising:
at least one computer storage that is not a transitory signal and that comprises instructions executable by at least one processor to:
receive at least one audio asset from at least one computer simulation;
responsive to metadata in the audio asset, generate a haptic asset; and
use the haptic asset to activate at least one haptic generator in at least one computer simulation controller.

13. The device of claim 12, wherein the audio asset has a frequency of two hundred Herz (200 Hz) or less.

14. The device of claim 12, wherein the instructions are executable to:
process the audio asset through at least one low pass filter prior to using the audio asset to generate the haptic asset

15. The device of claim 12, wherein the haptic generator comprises at least one eccentric rotating mass (ERM) device.

16. The device of claim 12, wherein the instructions are executable to:
present on at least one display at least one user interface (UI) comprising at least one input element selectable to enable or disable generating the haptic asset from the audio asset.

17. The device of claim 15, wherein the ERM device comprises:
a motor comprising a shaft extending into a hollow permanent magnet and coupled to an eccentric mass via the shaft.

18. The device of claim 12, comprising the at least one processor.
